(19) United States
(12) Patent Application Publication
(10) Pub. No.: US 2004/0267827 A1
(43) Pub. Date: Dec. 30, 2004

(54) Method, apparatus, and program for maintaining quota information within a file system

(75) Inventors: Joon Chang, Austin, TX (US); Mark Allen Grubbs, Round Rock, TX (US); Gerald Francis McBrearty, Austin, TX (US); Grover Herbert Neuman, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/610,787

(22) Filed: Jun. 30, 2003

(51) Int. Cl. G06F 7/00

(52) U.S. Cl. 707/200

(57) ABSTRACT

A mechanism is provided for maintaining quota information in extended attributes associated with a quota data file. A quota data file includes file control information, including attributes such as a file name. The quota data file control information includes a reference to an extended attributes directory. Each user record is stored as an extended attribute in the extended attributes directory. Each extended attribute also has file control data. The quota information for a user is stored in-line in the file control data.

### BACKGROUND OF THE INVENTION

1. Technical Field

The present invention relates to data processing systems and, in particular, to a method, apparatus, and program for maintaining quota information within a file system.

2. Description of Related Art

A server may allow users to store files in a file system hosted by the server, particularly in environments in which users may use any one of a plurality of client computers. For example, in a university, a student may login using a computer in the computer lab or a personal computer in a dormitory. The server may impose a storage limit for each user referred to as a quota.

Quota information may include a record for each user, which may include the amount of allowed storage space and the amount of used storage space. Current implementations store quota data for all users in a single file in the file system. The quota file is most typically stored as a flat file. Implementing quota support in such a manner involves creating new interfaces and methods to maintain the quota data.

Typically, an administrator assigns an alphanumeric user name, which is sometimes referred to as a user identification (user ID), to each user. This user name is used for user-level tasks, such as log-on, home directory, and the like. The administrator also assigns a numeric user identification (UID) to each user. This numeric UID is used for kernel-level and filesystem-level tasks, such as quota operations.

FIG. 1 illustrates a typical quota file structure in the prior art. Quota file 100 is created on a block-by-block basis. A typical block is 4096 bytes (4 k) in size and a typical quota record is 32 bytes in size. For example, block 102 stores quota records for users with numeric user identifications (UID) between 0 and 127 (4096÷32−1=127). One such record is quota record 112. Block 104 stores quota records for users with UIDs between 128 and 255. And block 106 stores quota records for users with UIDs between 256 and 383.

As shown in FIG. 1, the filesystem allocates blocks regardless of how much of the block will actually be used. For example, the file system allocates blocks 104 and 106 even though only one record is stored in each block. In the depicted example, record 114 may be for a user with a UID of 128 and record 116 may be for a user with a UID of 280. In this example, each record uses 32 bytes of data. Therefore, 4064 bytes are unused in each of blocks 104 and 106.

Ideally, UIDs are assigned consecutively and the unused space is minimized. However, the administrator assigning the IDs may wish to assign the UIDs logically. For example, the administrator may wish to assign users in one department UIDs starting at 1000 and to assign users in another department UIDs starting at 2000. However, gaps in UIDs result in unused file space. Furthermore, some file systems have relatively small file size restrictions which limit the number of users for which quota data can be stored.

Many file systems have asynchronous I/O, meaning the data is not always written to persistent storage when it is created or updated. Operations may be performed on the data efficiently while the data resides in memory. However, writing the data to persistent storage, such as a hard disk drive, is a relatively inefficient operation. In fact, quota information is not typically written to the file system very often, due to the performance hit associated with writing to persistent storage.

When the system crashes, any changes to the quota file in memory not written to the persistent storage become lost. Therefore, a system crash may necessitate that the entries for the entire set of quota data be rebuilt in order to guarantee correctness. The file system may rebuild quota data by confirming every quota, for each user, and determining how much storage is actually used by each user by inspecting the file system. This task can be time consuming for large file systems and/or a large number of users.

Moreover, many quota implementations require special mechanisms to manage quota information. For example, when a quota record is to be updated, code for file system must parse the file to locate the record. Then, the code for the file system must overwrite the record within the quota file. These operations require special code that may be time consuming to develop.

Therefore, it would be advantageous to provide an improved mechanism for maintaining quota information within a file system.

### SUMMARY OF THE INVENTION

The present invention provides a mechanism for maintaining quota information in extended attributes associated with a quota data file. A quota data file includes file control information, including attributes such as a file name. The quota data file control information includes a reference to an extended attributes directory. Each user quota record is stored as an extended attribute in the extended attributes directory. Each extended attribute also has file control data. The quota information for a user is stored in-line in the file control data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a typical quota file structure in the prior art;

FIG. 2 depicts a pictorial representation of a network of data processing systems in which the present invention may be implemented;

FIG. 3 is a block diagram of a data processing system that may be implemented as a server in accordance with a preferred embodiment of the present invention;

FIG. 4 is a block diagram illustrating a data processing system in which the present invention may be implemented;

FIG. 5 is a block diagram illustrating a file structure with an extended attribute in accordance with a preferred embodiment of the present invention;

FIG. 6 depicts an example quota file in accordance with a preferred embodiment of the present invention;

FIG. 7 is a flowchart illustrating the creation of a quota file in accordance with a preferred embodiment of the present invention; and

FIG. 8 is a flowchart illustrating the creation of a quota record in accordance with a preferred embodiment of the present invention.

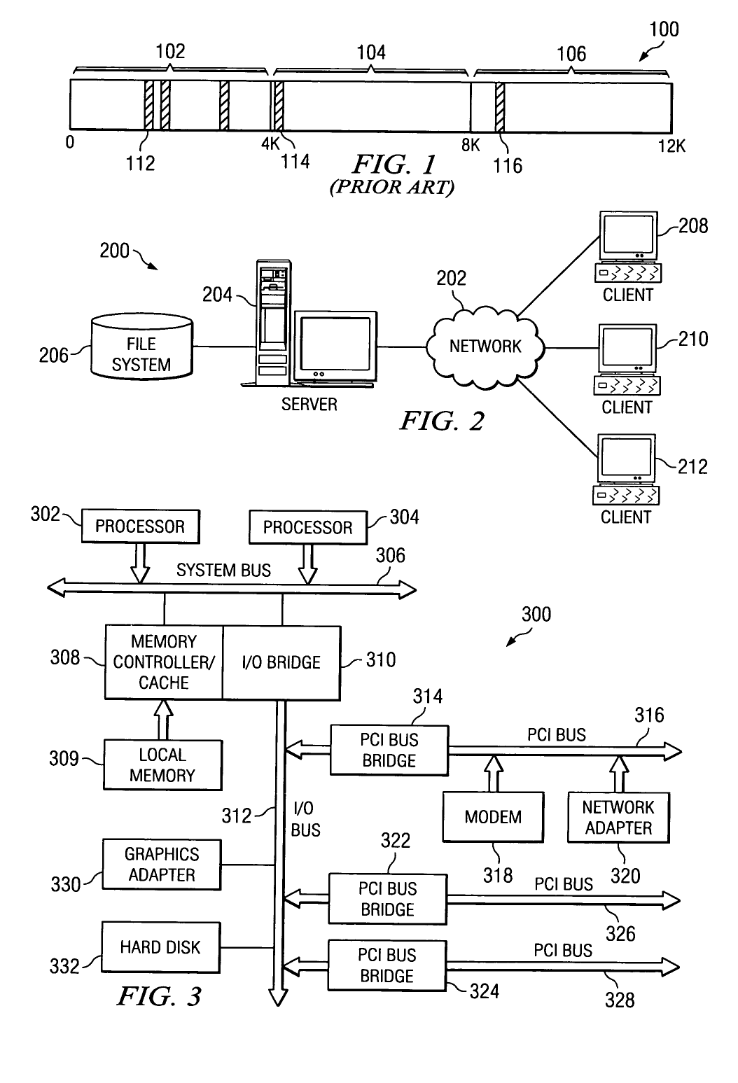

### DETAILED DESCRIPTION OF THE PREFERRED EMBODIMENT

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 and provides access to file system 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. Clients 208, 210, 212 may also provide access to other clients within the network. In a peer-to-peer implementation each client may access resources, such as storage, residing in other clients.

In accordance with a preferred embodiment of the present invention, server 204 allows users to store files in file system 206. The server imposes a storage limit for users referred to as a quota. The quota information is stored as a quota file in file system 206. Also, a client, such as client 208, may also allow other users to store files in its file system. Thus, a client may also impose a quota on users. For example, in a peer-to-peer implementation, a client may store a quota file for other clients in the network. Therefore, the examples described herein may apply to quota information in a client file system as well as a server file system.

The present invention provides a mechanism for maintaining quota information in extended attributes associated with a quota data file. A quota data file includes file control information, including attributes such as file ownership. The quota data file control information includes a reference to an extended attributes directory. Each user quota record is stored as an extended attribute in the extended attributes directory. Each extended attribute also has file control data. The quota information for a user is stored in-line in the file control data.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

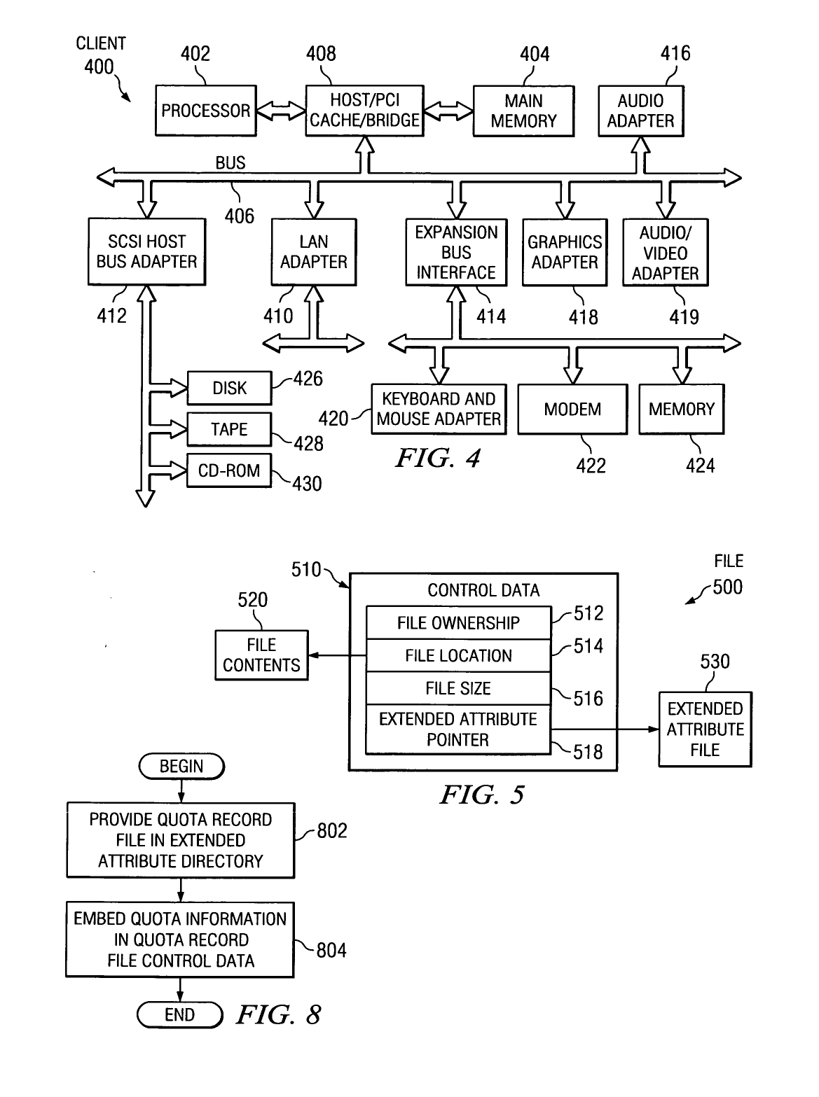

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards.

In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interfaces As a further example, data processing system 400 may be a personal digital assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

With reference to FIG. 5, a block diagram illustrating a file structure with an extended attribute is shown in accordance with a preferred embodiment of the present invention. The file structure represents a file stored in a file system. The file system may reside within a single storage device, such as a hard disk drive. However, a file system may also be implemented as a redundant array of independent disks (RAID), a database management system, or as a distributed database management system within the scope of the present invention. File 500 includes control data 510. The control data includes, for example, file ownership 512, file location 514, and file size 516. The example shown in FIG. 5 is meant as an example and not to limit the present invention. File location 514 references or points to the file contents 520.

Modern file systems allow an arbitrary number of extended attributes (EA) to be associated with a given file. These EAs permit additional information to be associated with a file without affecting the file contents. For example, an EA may be a comment or annotation for a file. Control data 510 also includes a reference or pointer 518 to the extended attribute file 530. The EA file may also include control data, file contents, and extended attributes in a manner similar to file 500.

Control data for any file generally has a specified size defined by the operating system. Many operating systems store file contents in-line within the control data, if possible, rather than allocating blocks of data. In such a case, the pointer to the file contents is null or overloaded with in-line data. For example, the file contents may be 16 bytes. The operating system may define the control data to be 128 bytes. Thus, the operating system may store the file contents in-line within control data 510, rather than allocating a 4 k block for file contents 520. The same may apply to EA 530, wherein the operating system may store extended attribute data in-line within the control data for EA 530 if the EA data is of a small enough size.

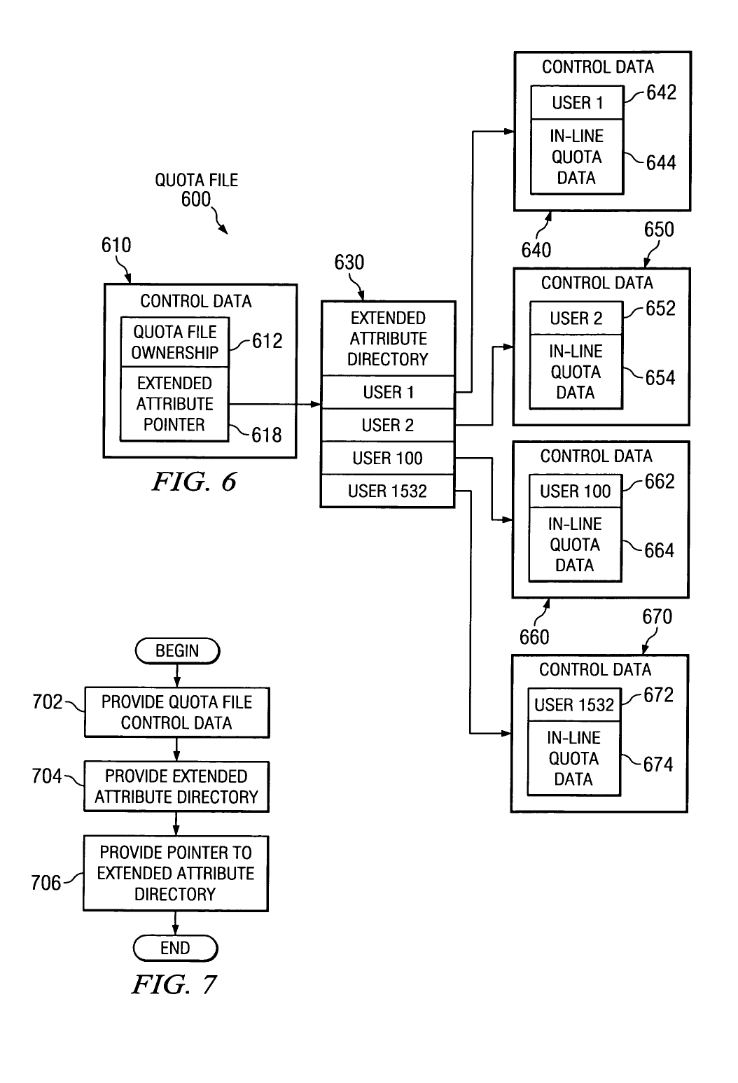

FIG. 6 depicts an example quota file in accordance with a preferred embodiment of the present invention. A quota file may have the same properties as defined above with respect to file 500 in FIG. 5. Quota data file 600 includes control data 610, including attributes such as file ownership 612. The quota file control data also includes a reference to extended attributes directory 630. Each user record is stored as an extended attribute in the extended attributes directory.

Each extended attribute also has control data, shown as control data 640, 650, 660, 670. If the extended attribute contents are smaller than a predetermined size, the file system stores the extended attribute contents in-line within the control data. In such a case, the pointer to the extended attribute contents is null or overloaded with in-line data. Otherwise, the file system allocates at least one block (e.g. a 4 k block) for the file contents, which would likely be unused space. However, since quota data for a user quota record is typically of a small size, e.g. 32 bytes, this data can be stored in-line within the control data, thus providing a consistently small amount of space for each quota data record.

Thus, in the example shown in FIG. 6, control data 640 includes ownership (user 1) 642 and in-line quota data 644. Similarly, control data 650 includes ownership (user 2) 652 and in-line quota data 654; control data 660 includes ownership (user 100) 662 and in-line quota data 664; and, control data 670 includes ownership (user 1532) 672 and in-line quota data 674.

The operating system allocates only the storage space necessary to store the quota record control data for each user. Therefore, the quota file of the present invention avoids the unused allocated space associated with the prior art. Furthermore, a directory naturally orders its contents for lookup. Therefore, the extended attributes directory provides pre-existing functionality. Each quota record can be treated as a separate file; therefore, the mechanisms for inserting, removing, modifying, and reordering quota records are handled by the extended attribute interfaces and directory manipulation code, which are already part of the operating system and file system. Creating a file, deleting a file, modifying a file, and sorting a directory are standard operations that are part of operating system and file system code. Since extended attributes are actual files, the pre-existing operating system and file system code is used to perform operations on these files. Thus, the pre-existing operating system and file system code is used to perform the quota system operations of the present invention.

For example, when a user is added to the file system, the operating system simply adds an extended attribute file for the user to the extended attributes directory. When a user is removed from the file system, the corresponding extended attribute file is simply deleted. A user may also request an increase in the allocated storage space. In this case, the administrator would modify the quota value in the appropriate extended attribute. The extended attribute contents, which are stored in-line within the control data, are then written to the file system. These operations make use of previously existing operating system and file system code.

Furthermore, the number of users for which quota data can be stored is limited only by the size of the file system. In other words, the number of users is only limited by the amount of space that can be allocated to the users, because the quota data is only a small fraction of the space allowed for each user and, thus, is unlikely to outgrow the file system.

As known in the art, control data, which is a file's meta data, may be journaled in a persistent log, which is typically very efficient. The operating system journals the control data in a persistent log using a synchronous disk write. In other words, when the file system creates or modified control data, the operating system also writes the changes to the control data to persistent storage. A journaled file system may start with data as it was created and apply these recorded changes, in chronological order, to arrive at the current state of the data. Thus, in a journaled file system, replaying the file system log after a crash keeps the extended attributes in sync with the file system metadata.

In the present invention, the quota records are stored as extended attributes, which are actually control data for the quota file. Since the quota record data is stored in-line within the control data for the extended attribute file, any changes to quota record data is actually a change to meta data. These changes are recorded by the journaled file system. If the system crashes, the file system can replay the file system log to restore the state of the quota file control data, the extended attributes directory, the extended attribute control data, and ultimately the quota record data stored in-line within the extended attribute control data for each quota record, thus eliminating a lengthy reconstruction of the entire quota data.

With reference now to FIG. 7, a flowchart is shown illustrating the operation of an operating system in creating a quota file for a file system in accordance with a preferred embodiment of the present invention. The process begins and the operating system provides a quota file control data (step 702). Then the operating system provides an extended attribute directory (step 704) and provides a pointer in the quota file control data to the extended attribute directory (step 706). Thereafter, the process ends.

Turning to FIG. 8, a flowchart is shown illustrating the operation of an operating system in creating a quota record in accordance with a preferred embodiment of the present invention. The process begins and the operating system provides an extended attribute file in the extended attribute directory (step 802). Then, the operating system embeds the quota information in-line within the extended attribute file control data (step 804). Thereafter, the process ends.

Thus, the present invention solves the disadvantages of the prior art by providing a quota file that stores quota information in extended attributes in an extended attributes directory. The extended attributes directory naturally orders its content for lookup. The quota information is of a small size that may be stored in-line, thus providing a consistently small amount of space for each quota data record. The present invention uses existing extended attribute interfaces and directory manipulation code to insert, remove, update, and reorder quota records, reducing implementation development time. Furthermore, the number of users is not limited by file size restrictions. Also, control data may be journaled in a persistent log, which is a very efficient and synchronous disk write. Thus, the quota data may be quickly and easily restored by replaying the file system log after a crash.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for maintaining quota information for a file system, the method comprising:
providing a quota file, wherein the quota file stores quota information for users of a file system; and
storing quota records as extended attributes for the quota file.

2. The method of claim 1, wherein the quota file has quota file control data.

3. The method of claim 2, wherein the quota file control data includes a reference to an extended attributes directory.

4. The method of claim 3, wherein the step of storing quota records as extended attributes includes storing the extended attributes in the extended attributes directory.

5. The method of claim 1, wherein each extended attribute has extended attribute control data.

6. The method of claim 5, wherein quota information is stored in-line within the extended attribute control data.

7. The method of claim 1, wherein the extended attributes are written synchronously.

8. The method of claim 1, wherein the extended attributes are journaled in a file system log.

9. The method of claim 8, further comprising:
responsive to a system crash, rebuilding the quota file by replaying the file system log.

10. A quota file for storing quota information for users of a file system, comprising:
quota file control data;
an extended attributes directory referenced in the quota data control data;
at least one quota record extended attribute stored in the extended attributes directory, wherein the quota record extended attribute includes extended attribute control data and wherein quota information is stored in-line within the extended attribute control data.

11. An apparatus for maintaining quota information for a file system, the apparatus comprising:
means for providing a quota file, wherein the quota file stores quota information for users of a file system; and
means for storing quota records as extended attributes for the quota file.

12. The apparatus of claim 11, wherein the quota file has quota file control data.

13. The apparatus of claim 12, wherein the quota file control data includes a reference to an extended attributes directory.

14. The apparatus of claim 13, wherein the means for storing quota records as extended attributes includes means for storing the extended attributes in the extended attributes directory.

15. The apparatus of claim 11, wherein each extended attribute has extended attribute control data.

16. The apparatus of claim 15, wherein quota information is stored in-line within the extended attribute control data.

17. The apparatus of claim 11, wherein the extended attributes are written synchronously.

18. The apparatus of claim 11, wherein the extended attributes are journaled in a file system log.

19. The apparatus of claim 18, further comprising:
means for rebuilding the quota file by replaying the file system log after a system crash.

20. A computer program product, in a computer readable medium, for maintaining quota information for a file system, the computer program product comprising:
a quota file, wherein the quota file stores quota information for users of a file system; and
instructions for storing quota records as extended attributes for the quota file.

21. The computer program product of claim 20, wherein the quota file has quota file control data.

22. The computer program product of claim 21, wherein the quota file control data includes a reference to an extended attributes directory.

23. The computer program product of claim 22, wherein the instructions for storing quota records as extended attributes include instructions for storing the extended attributes in the extended attributes directory.

24. The computer program product of claim 20, wherein each extended attribute has extended attribute control data.

25. The computer program product of claim 24, wherein quota information is stored in-line within the extended attribute control data.

26. The computer program product of claim 20, wherein the extended attributes are written synchronously.

27. The computer program product of claim 20, wherein the extended attributes are journaled in a file system log.

28. The computer program product of claim 27, further comprising:
instructions for rebuilding the quota file by replaying the file system log after a system crash.
